(19) United States
(12) Patent Application Publication
(10) Pub. No.: US 2016/0124365 A1
(43) Pub. Date: May 5, 2016

(54) IMAGE FORMING APPARATUS AND CONSUMABLE CARTRIDGE MANAGING METHOD

(71) Applicant: KYOCERA Document Solutions Inc., Osaka (JP)

(72) Inventor: Tetsuya NISHINO, Osaka (JP)

(73) Assignee: KYOCERA Document Solutions Inc., Osaka (JP)

(21) Appl. No.: 14/929,302

(22) Filed: Oct. 31, 2015

(30) Foreign Application Priority Data
Oct. 31, 2014 (JP) 2014-223015

(51) Int. Cl. G03G 15/00

(52) U.S. Cl. CPC G03G 15/5091

(57) ABSTRACT

Provided is an image forming apparatus and a consumable cartridge managing method including a read/write part to read/write an information piece from/to the IC tag and a control part having a memory part on which a first apparatus intrinsic number is written. The control part determines whether or not a second apparatus intrinsic number is written on a use history region of the memory when the consumable cartridge is loaded. If the result is No, the control part writes the first apparatus number on the use history region and records additionally the first intrinsic number as the second apparatus intrinsic number on a replacement history region/loading history region of the memory part. If the result is Yes, the control part records additionally the second apparatus intrinsic number on the replacement history region/loading region of the memory part.

### INCORPORATION BY REFERENCE

This application is based on and claims the benefit of priority from Japanese Patent Application No. 2014-223015 filed on Oct. 31, 2014, the entire contents of which are hereby incorporated by reference.

### BACKGROUND

The present disclosure relates to an image forming apparatus that uses a consumable cartridge such as a toner cartridge with an IC tag and a consumable cartridge managing method.

Many electro-photographic dry type copiers, printers, and the like are loaded into a toner cartridge in which an amount of toner (color fixative) as a consumable is filled for printing a specified number of sheets (for example, 10000 sheets) and mere replacement of the toner cartridge with a new one, when the toner in the toner cartridge is fully used up, completes the toner replenishment.

In addition, a managing method of such a toner cartridge has been proposed for various purposes by attaching a memory chip, an IC tag with a memory chip or the like to the toner cartridge together with providing a memory chip read/write device to the electro-photographic dry type copiers, printers and the like.

### SUMMARY

An image forming apparatus according to the present disclosure is configured to replaceably load a consumable cartridge with an IC tag having a memory with a use history region. The image forming apparatus, also, includes a read/write part and a control part. The read/write part is configured to read/write an information piece from/to the IC tag. The control part has a memory part on which a first apparatus intrinsic number is written. The control part is configured to determine, when the consumable cartridge is loaded, whether or not a second apparatus intrinsic number as a use history is written on the use history region of the memory. The control part is configured to write the first apparatus intrinsic number on the use history region if the second apparatus intrinsic number is not written on the use history region and to record additionally the first apparatus intrinsic number as the second apparatus intrinsic number on a replacement history region or a loading history region of the memory part. The control part is configured to record additionally the second apparatus intrinsic number on the replacement history region or the loading history region of the memory part if the second intrinsic machine body number is written on the use history region.

An image forming apparatus according to the present disclosure is configured to replaceably load a consumable cartridge with an IC tag having a memory with a use history region. The image forming apparatus also includes a reread/write part and a control part. The read/write part is configured to read/write from/to the IC tag. The control part is configured to determine, when the consumable cartridge is loaded, whether or not a second apparatus intrinsic number is written as a use history on the use history region of the memory. The control part also is configured to write the first apparatus intrinsic number on the use history region if the second apparatus intrinsic number is not written on the use history region and to record additionally the first intrinsic machine body number as the second intrinsic machine body number on a replacement history region or a loading history region of the memory part. The control part is configured to write additionally the second apparatus intrinsic number on the replacement history region or the loading history region of the memory part if the second apparatus intrinsic number is written on the use history region and concurrently if the second apparatus intrinsic number is different from the first apparatus intrinsic. The control part is configured to write additionally the second apparatus intrinsic number that is added with a specific identification information piece on the replacement history region or the loading history region of the memory part if the second apparatus intrinsic number is written on the use history region and concurrently if the second apparatus intrinsic number is identical with the first apparatus intrinsic number.

A consumable cartridge managing method according to the present disclosure is a method of managing consumable cartridge in an image forming apparatus. The image forming apparatus is configured to replaceably load a consumable cartridge with an IC tag having a memory with a use history region. The image forming apparatus, also, includes a read/write part and a control part. The read/write part is configured to read/write an information piece from/to the IC tag. The control part has a memory part on which a first apparatus intrinsic number is written. The control part determines when the consumable cartridge is loaded, whether or not a second apparatus intrinsic number as a use history is written on the use history region of the memory. The control part is configured to write the first apparatus intrinsic number on the use history region if the second apparatus intrinsic number has is not written on the use history region. The control part, also, records additionally the first apparatus intrinsic number as the second apparatus intrinsic number on a replacement history region or a loading history region of the memory part. The control part records additionally the second apparatus number on the replacement history region or the loading history region of the memory part if the second apparatus intrinsic number is written on the use history region.

### BRIEF DESCRIPTION OF THE DRAWINGS

FIG. 1A is a schematic view showing a configuration of a copy machine 1 to which the present disclosure is applied;

FIG. 1B is a schematic view showing a configuration of a transceiver circuit of the copy machine 1 to which the present disclosure is applied;

FIG. 2A is a view (memory map) showing a memory area allocation on a memory part 63b of the copy machine 1;

FIG. 2B is a view (memory map) showing a memory area allocation on a memory part 63b of the copy machine 1;

FIG. 3A is a block diagram showing a configuration of an IC tag at a toner cartridge 59;

FIG. 3B is a memory map of a memory 59b;

FIG. 3C is a memory map of the memory 59b;

FIG. 3D is a memory map of the memory 59b;

FIG. 4 is a flowchart showing a flow of operation of a first exemplary embodiment of the present disclosure;

FIG. 5A is an output example showing an event report in the first exemplary embodiment of the present disclosure;

FIG. 5B is an output example showing an event report in the first exemplary embodiment of the present disclosure;

FIG. 5C is an output example showing an event report in the first exemplary embodiment of the present disclosure;

FIG. 6 is a flowchart showing a flow of operation of a second exemplary embodiment of the present disclosure;

FIG. 7A is an output example showing an event report in the second exemplary embodiment of the present disclosure;

FIG. 7B is an output example showing an event report in the second exemplary embodiment of the present disclosure;

FIG. 7C is an output example showing an event report in the second exemplary embodiment of the present disclosure;

FIG. 8 is a flowchart showing an output operation of a third exemplary embodiment of the present disclosure;

FIG. 9 is a display example of a liquid crystal display part 62 in the third exemplary embodiment of the present disclosure;

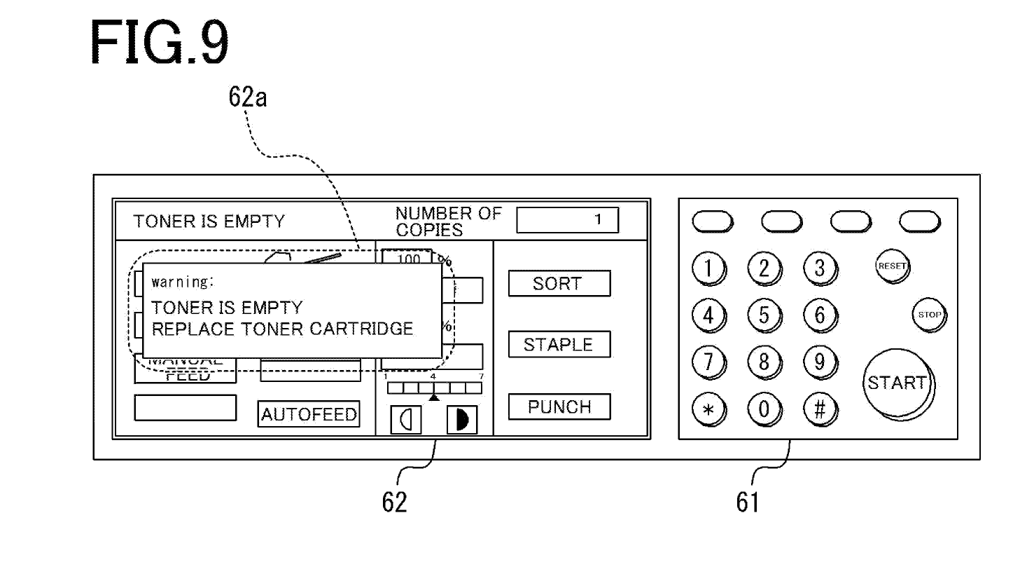

FIG. 10A is an output example showing an event report in the second exemplary embodiment of the present disclosure;

FIG. 10B is an output example showing an event report in the second exemplary embodiment of the present disclosure; and

FIG. 10C is an output example showing an event report in the second exemplary embodiment of the present disclosure.

### DETAILED DESCRIPTION

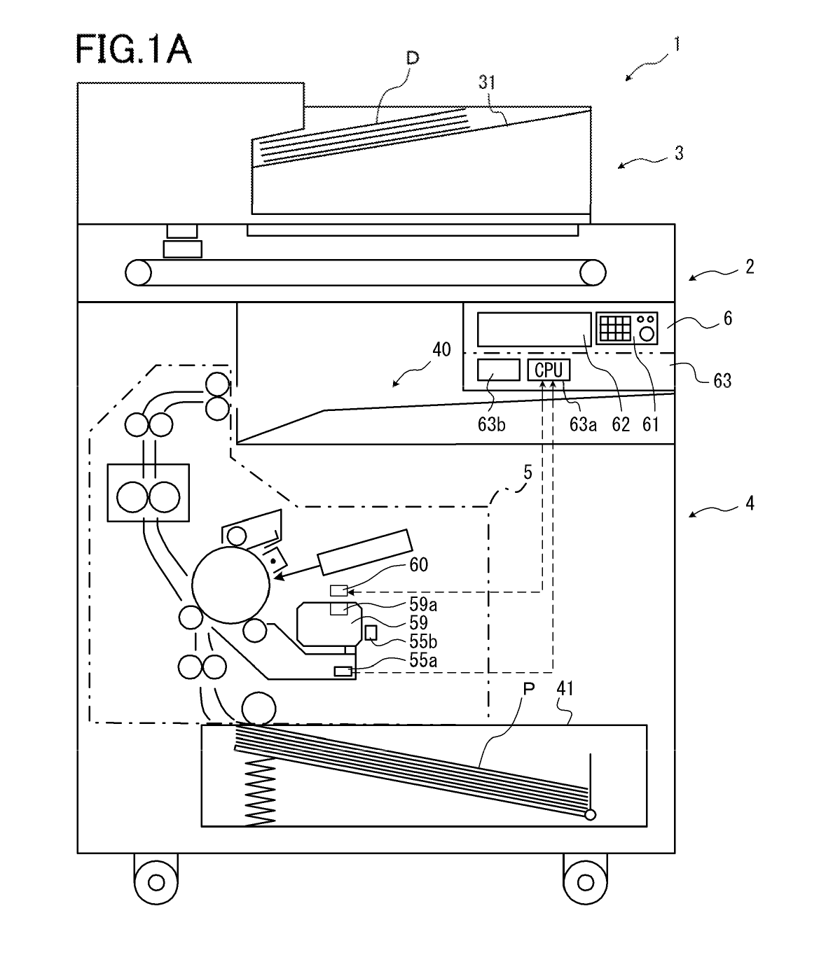

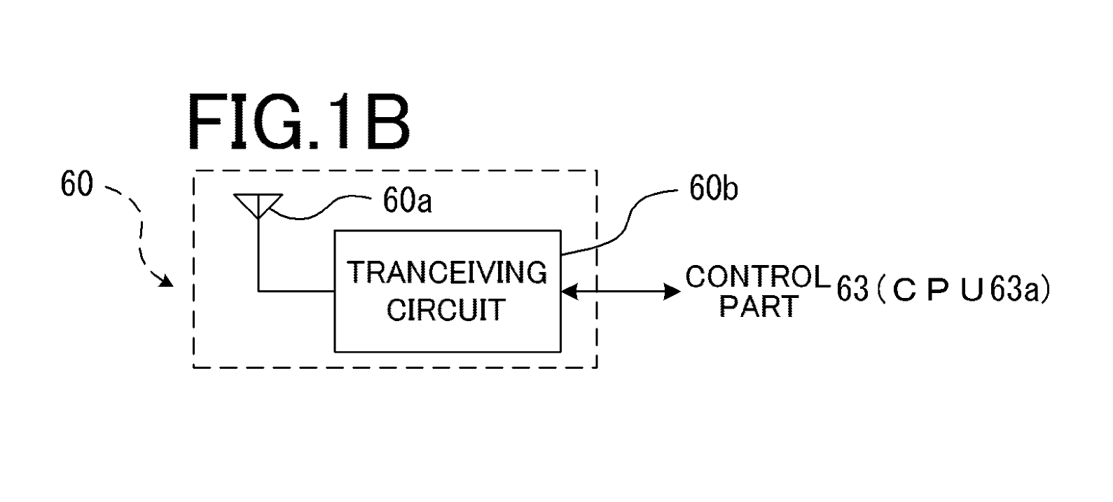

Next, exemplary embodiments of the present disclosure will be specifically described with reference to the drawings. An image forming apparatus of the present exemplary embodiment is a copy machine 1 to which an electro-photographic system is applied. Referring to FIG. 1A, the copy machine 1 includes a scanner part 2 with an ADF (Auto Document Feeder: manuscript reading apparatus) 3, a main body part 4, and an operation part 6.

The ADF 3 is mounted on the scanner part 2 and the scanner part 2 is mounted on the main body part 4. In addition, between the scanner part 2 and the main body part 4, there is formed a sheet discharge space 40. It is to be noted that while the present exemplary embodiment will be described by giving an example in which the copy machine 1 is applied, the image forming apparatus of the present disclosure includes, for example, a printer and an MFP (Multi-Function Peripheral).

The ADF 3 is configured to feed a manuscript D placed on a manuscript mount part 31 one by one in a sequential manner and to convey the manuscript D to an opposite position of the scanner part 2. The scanner part 2 reads an image on a surface of the conveyed manuscript D. It is to be noted that the inside of each of the scanner part 2 and the ADF 3 is a known configuration in general and therefore illustration and detailed description thereof are omitted for the sake of brevity.

The main body part 4 has a printing part 5 and a sheet paper cassette 41. Since main components of this printing part 5 and an inner structure of the sheet paper cassette 41 are the same as those being in common use and therefore illustration and detailed description thereof are omitted in the present exemplary embodiment. A description of the printing part 5 will be made briefly. A recording paper is fed from the paper cassette 41, an image is formed on a surface of the recording paper P by a toner, and the recording paper P is discharged into the sheet discharge space 40 after the recording paper P is subjected to a heat fixing process and the like.

In the present exemplary embodiment, a toner cartridge 59 in which toner is filled is loaded at a portion of the printing part 5 and the toner is taken out from the toner cartridge 59 when the image is formed on the recording paper P.

A sensor 55a is provided in the vicinity of a toner outlet of the toner cartridge 59.

An exemplary operation of this sensor 55a is that on the sensor 55a a fixed amount of toner is always accumulated, an image is formed on the surface of the recording paper P with the accumulated toner, and the toner is taken out from the toner cartridge 59 in a successive manner with the reduction of the accumulated toner. However, when the toner cartridge 59 is empty, the amount of the accumulated toner on the sensor 55a begins to reduce and therefore the image formed on the recording paper P gets blurred gradually. Thus, a control part 63 to be described later monitors the accumulated amount of toner on the sensor 55a to detect that the toner cartridge 59 is empty (no toner residual amount).

In addition, in the vicinity of the toner cartridge 59 there is provided a sensor group 55b. This sensor group 55b which is made up of an optical sensor for detecting whether or not the toner cartridge 59 is loaded and a switch for detecting motion of a lock lever that locks the toner cartridge 59, and other elements, and is configured to detect a loaded/unloaded condition of the toner cartridge 59.

It is to be noted that while the present exemplary embodiment shows only one type of toner cartridge 59 describes how to manage the toner cartridge 59, in a case where the copy machine 1 that is capable of forming a multi-color (for example, black and red) image and forming a full-color image (cyan, magenta and yellow, in addition to black), multi-color toner may be filled in the single toner cartridge 59 or plural toner cartridges 59 may be loaded one by one color.

In addition, the toner cartridge 59 is filled, as an example, with the toner enough to form an image on printing 10000 sheets of the recording paper P and a regular use method is regulated for ease of toner supply to the copy machine 1, the regular or supported use method being that when the toner in the toner cartridge 59 is used up (when image formations on 10000 sheets of recording paper P are completed or when no toner cannot be taken out from the toner cartridge 59), the toner cartridge 59 is replaced with an used toner cartridge 59.

The copy machine 1 of the present exemplary embodiment employs an RFID (Radio Frequency IDentification) tag for managing the toner cartridge 59. This RFID tag is constituted by an IC tag 59a that is assembled in the toner cartridge 59 and a communication device 60 that is provided in the printing part 5.

As shown in FIG. 1B, this communication device 60, which is made up of an antenna 60a and a transceiver circuit 60b for transceiving high frequency (electromagnetic) signals, is configured to communicate with the IC tag 59a by control of a control part 63 to be described later.

The IC tag 59a, which is made up of an antenna (not shown) for transceiving the above-mentioned high frequency signals and an IC chip (to be described later) having a memory that can operate by a high frequency electric power received by this antenna and a control circuit, is capable of reading/writing various information pieces via the communication device 60.

When the toner cartridge 59 is loaded in the spec portion of the printing part 5, for enabling the RFID tag, which is constituted by these IC tag 59a and communication device 60, to achieve the above-mentioned reading/writing of the various information pieces in a contactless manner, the IC tag 59a and the communication device 60 are so positioned as to be a close relationship therebetween. However, as to how these members are installed, how long a distance is set therebetween, how the writing/reading operates, and the like, detailed descriptions are omitted as these items do not constitute the present disclosure.

The operation part 6 is made up of, for example, an operation buttons 61, the liquid crystal display part 62, and the control part 63 having a CPU (Central Processing Unit), a memory part 63b and the like.

As the operation buttons 61, there are provided a start button for ordering a start of a scanning operation and an image forming operation, a stop for ordering a stop of the start of scanning operation and the image forming operation, a reset button that is manipulated when various set conditions of the copy machine 1 are brought into reset conditions, and numeric keys for inputting the number of recording sheets and the like.

The crystal liquid display 62, in addition to display conditions of the copy machine 1, how an image is being formed, and the number of printing copies, has, for example, a touch panel that is allowed for performing functions of double sided printing, black/white inversion, a magnification setting, printing density setting and the like, in addition to the operation buttons 61 (especially the numeric keys).

The memory part 63b has a volatile region that a memory device such as a RAM (Random Access Memory) uses and a non-volatile region that a memory device such as, a flash memory and a HDD (Hard Disk Drive) uses.

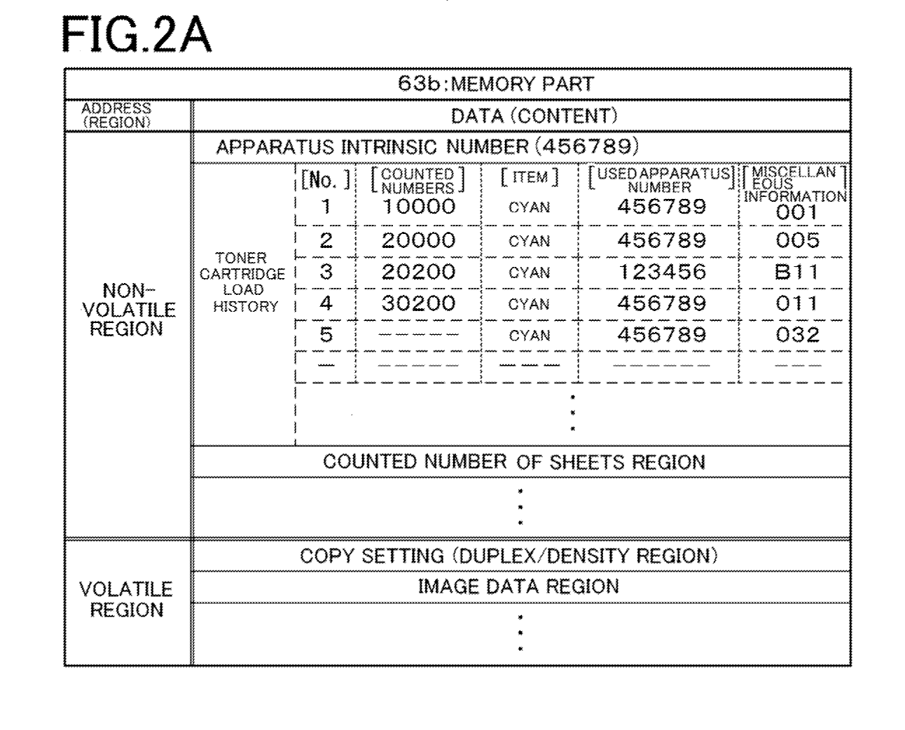

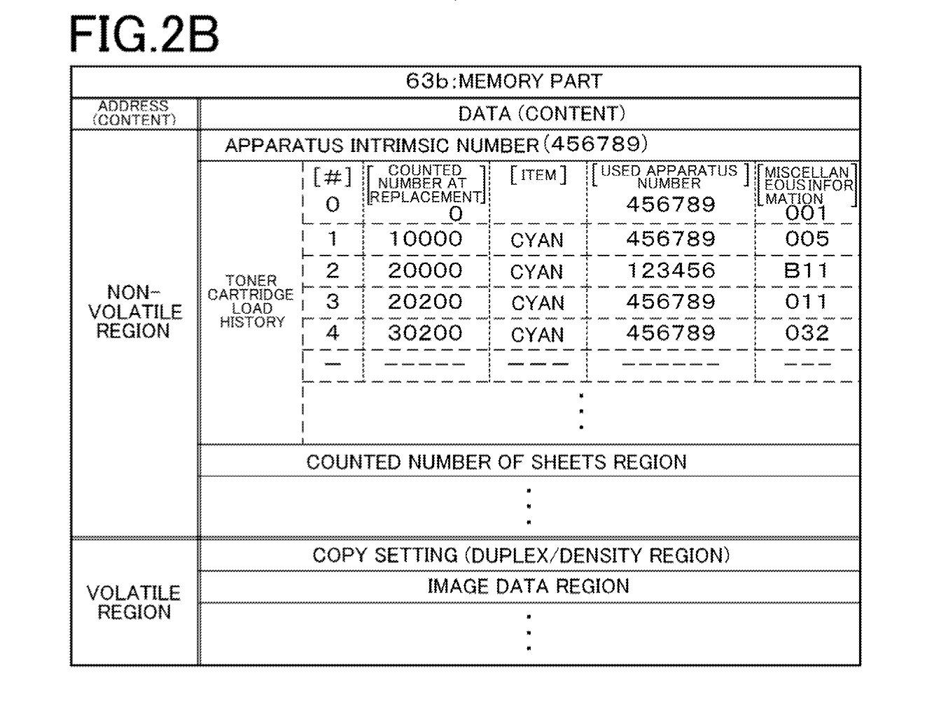

Here, with reference to FIG. 2A and FIG. 2B, a memory area allocation of the memory part 63 will be described. It is to be noted that FIG. 2A is different from FIG. 2B in how to accumulate the history of the toner cartridge 59 and therefore these are to be differently explained.

First of all, FIG. 2A, one of them, is indicative of how to accumulate a loading history of the toner cartridge 59. Referring to FIG. 2A, on the non-volatile region of the memory part 63b, there are provided an apparatus intrinsic number region, a toner cartridge loading history region, and a counted number of sheets region. An apparatus intrinsic number (serial number) that is to be written on this apparatus intrinsic number is determined and given when the copy machine is produced, adjusted or shipped, and is normally not rewritten. That is to say, the example shown in FIG. 2A indicates that the apparatus intrinsic number is “456789”.

On the toner cartridge loading history region, a toner cartridge loading history number column is written in an addition manner whenever the toner cartridge 59 is loaded. One toner cartridge loading history number column records, when the toner cartridge 59 is loaded, a numeral that is indicative of the loaded order of the toner cartridge 59 (on the column indicated with No.), an item name (that is indicative of the color of toner), and an used apparatus intrinsic number as a unique number for an apparatus (this apparatus or another copy machine 1) to which the toner cartridge 59 is loaded for the first use.

It is to be noted that the counted number of sheets is not recorded when the toner cartridge 59 is loaded and the counted number of sheets as of when the toner cartridge 59 is unloaded (to be described later).

In addition, on the toner cartridge loading history region, regions that remain blanks (that are indicated with a vertical dotted line in FIG. 2A) are to be recorded with various information pieces whenever the toner cartridge 59 is loaded and normally recorded information pieces are not overwritten or deleted.

Miscellaneous information column of the toner cartridge loading history region is used for a serial number of the toner cartridge 59 and the like. However, this does not constitute a feature of the present disclosure. Thus, a description of this is omitted and the present disclosure is established even without this column.

In the example shown in FIG. 2A, the numerals or characters indicated in each of the columns of the toner cartridge loading history region means that as to each of the toner cartridges 59 at the first, second, and fourth loads has a toner color of “cyan” and the apparatus intrinsic number “456789” (that is, this apparatus) of the copy machine 1 that is the first apparatus for the toner cartridge 59 to be loaded. These toner cartridges 59 were unloaded when the counted number of the sheets reached 10000, 20000, and 30000, respectively.

The toner cartridge 59 that was loaded at the third replacement was used in a different copy machine 1 whose apparatus intrinsic number is “12345” and had a toner color of “cyan”. This third loaded toner cartridge 59 is indicated as being unloaded when the counted number of sheets reached 20200.

The fifthly loaded toner cartridge 59 is indicated such that its toner color is “cyan”, the first copy machine 1 for this toner cartridge 59 to be load has an apparatus intrinsic number “456789” (that is, this apparatus), and this toner cartridge 59 has been loaded in this copy machine 1 until now.

The counted number of sheets region is provided for storing how many images are there that this copy machine 1 formed by using the toner in the toner cartridge 59. On this counted number of sheets region, the number of recording sheets P on which images are formed is added sequentially.

It is to be noted that while the volatile region of the memory 63 has an region for retaining copy setting and an region for storing, for example, image data pieces that the scanner part 2 reads and setting information pieces of each the part in a temporal or permanent manner, such matters do not constitute the present disclosure and therefore its description is omitted for the sake of brevity.

Next, FIG. 2B is indicative of how to accumulate a replacement history of the toner cartridge 59. Referring to FIG. 2B, on the non-volatile region of the memory part 63b, there are provided an apparatus intrinsic number region, a toner cartridge replacement history region, and a counted number of sheets region. This apparatus intrinsic number region, this counted number of sheets region, and a volatile region of the memory part 63b are the same as those shown in FIG. 2A and therefore their detailed descriptions are omitted for the sake of brevity.

It is to be noted that in the example shown in FIG. 2B which accumulates the toner cartridge replacement history, the loading of the toner cartridge 59 is regarded as the #0th replacement for convenience and the counted number of sheets upon replacement is set to be 0.

The toner cartridge replacement history region, which is to be written additionally whenever the toner cartridge 59 is unloaded and loaded, records, in addition to a numeral (in the column labeled by #) that is indicative of the replaced sequence of the toner cartridge 59, the counted number of sheets at the time of the replacement, an item name (that is indicative of a toner color and the like), and a used apparatus intrinsic number as a unique number for an apparatus (this apparatus or another copy machine 1) to which the toner cartridge 59 was loaded for the first use, as a set.

On the toner cartridge replacement history region, regions that remain blanks (that are indicated with a vertical dotted line in FIG. 2B) are to be recorded with various information pieces whenever the toner cartridge 59 is loaded and unloaded, and normally recorded information pieces are not overwritten or deleted.

It is to be noted that as to a miscellaneous information column of the toner cartridge replacement history region and a volatile region of the memory region 63, these are the same as those described in FIG. 2A and therefore their detailed descriptions are omitted for the sake of brevity.

In the example shown in FIG. 2B, what the numerals or characters indicated in each of the columns of the toner cartridge replacement history region mean is that the #0 column indicates the time at which this apparatus or copy machine 1 began to use and the toner color being “cyan”.

The toner cartridges 59 that are at the first, third, and fourth replacements (#1, #3, and #4) indicate that their replacements are made when the counted number of sheets is 10000, 20200, and 30200, respectively, their toner colors are ‘cyan’, and the apparatus intrinsic number “456789” (that is, this apparatus) of the copy machine 1 that is the first apparatus for the toner cartridge 59.

The loaded toner cartridge 59 after the second replacement was used in a different copy machine 1 whose apparatus intrinsic number is “123456” and has a toner color of “cyan”. This or the second replaced toner cartridge 59 is indicated as being replaced when the counted number of sheets reached 200000.

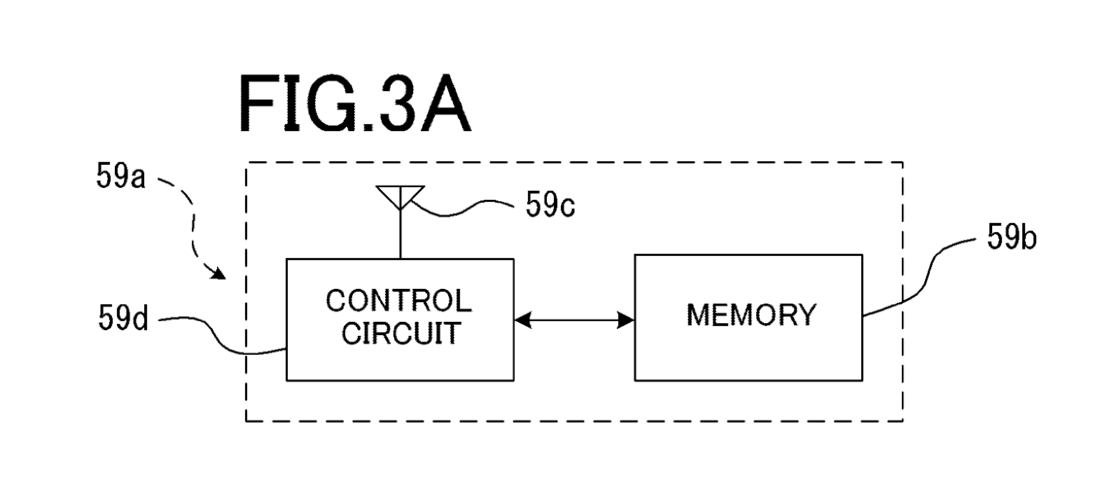

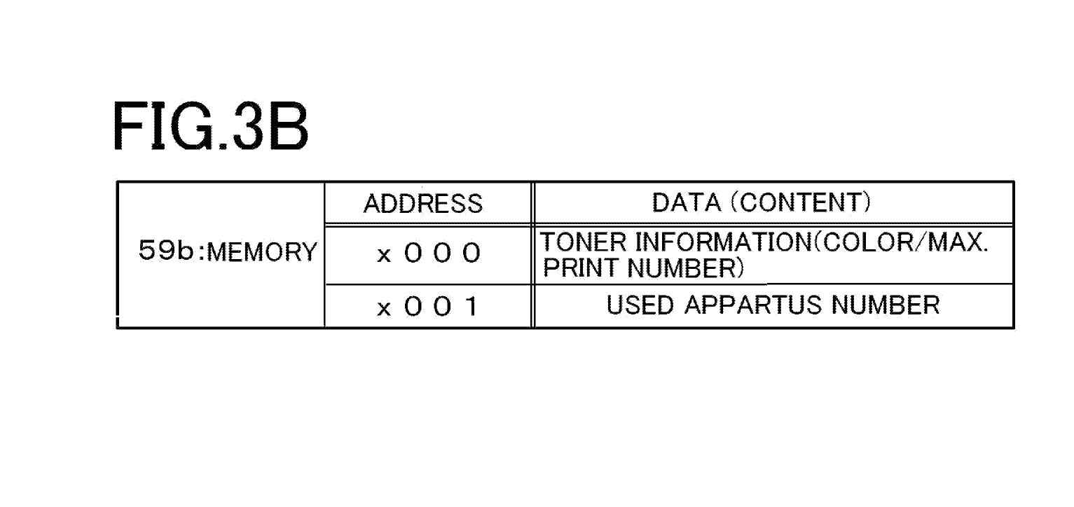

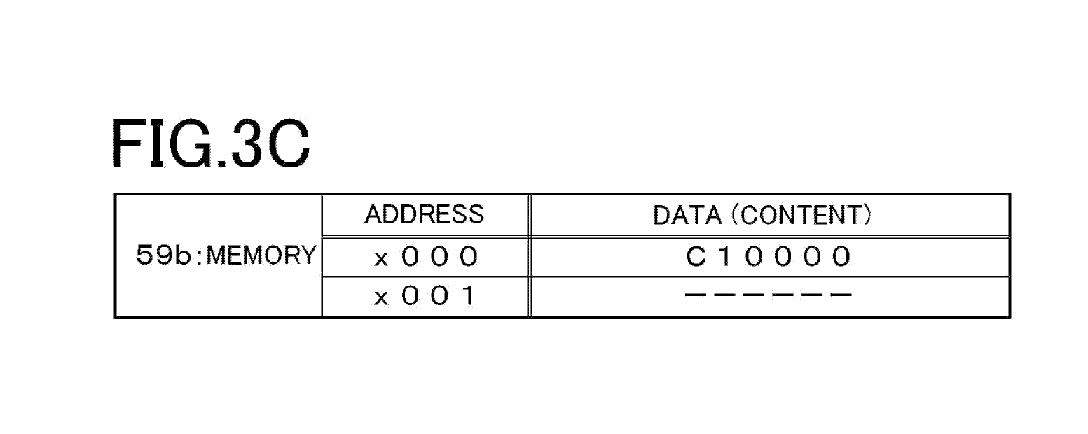

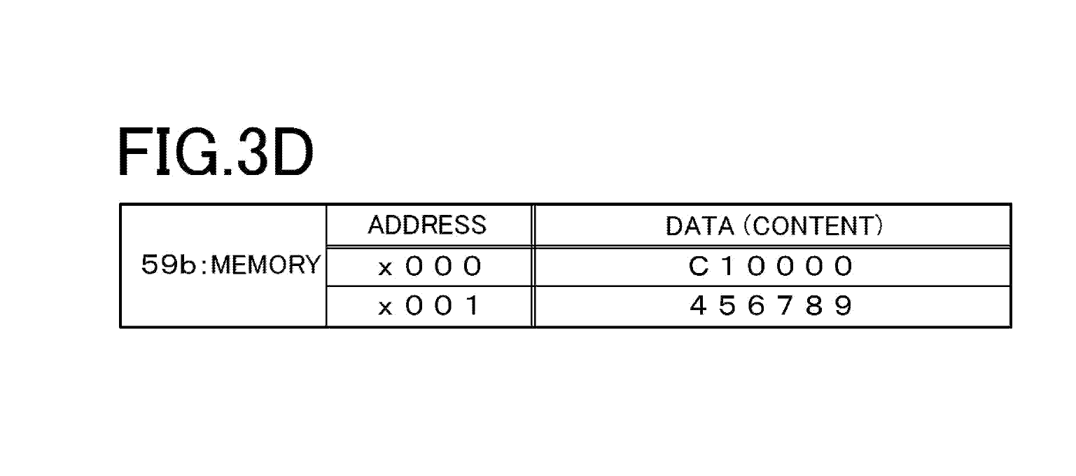

When the toner cartridge 59 is loaded into the copy machine 1, the above-mentioned apparatus intrinsic number is transmitted to the IC tag 59a that the toner cartridge 59 has. Referring to FIG. 3, as shown in FIG. 3A, the IC tag 59a includes, in addition to the memory 59b, an antenna 59c and a control circuit 59d.

The memory 59b with such an IC tag 59a is not large in memory capacity and is usually limited in operating power, which makes it possible to achieve a reading/writing in a short time. As shown in FIG. 3B, the memory 59b is configured to be written minimum information.

As the memory map that is shown in FIG. 3B indicates, in the memory 59b of the present exemplary embodiment, an address x000 provides a region on which toner information pieces (color: as an example, C is indicative of cyan/maximum number of formable images: 10000 sheets) are written and an address x001 provides an region on which an apparatus intrinsic number.

The toner cartridge 59 of the present exemplary embodiment is not intended to be loaded into plural different apparatuses one after another. Thus, when this toner cartridge 59 is an unused toner cartridge, no item is recorded in the address x001 (“----” indicates a space).

When the unused toner cartridge 59 is loaded into the copy machine 1, and apparatus intrinsic number that is unique for the copy machine 1 is written in the address x001. That is to say, which copy machine 1 uses this toner cartridge 59 is recorded.

### First Exemplary Embodiment

Hereinbelow, a process flow of the first exemplary embodiment of the present disclosure will be described. It is to be noted that this first exemplary embodiment shall apply the method of accumulating the loading history of the toner cartridge 59 as shown in FIG. 2A.

In addition, the first exemplary embodiment supposes that the unused toner cartridge 59 is filled with toner enough to form images on 10000 sheets of recording paper P, each portion of the copy machine 1 is free from factors that cause errors in printing and counting the number of sheets, the toner in the toner cartridge 59 to be replaced with the unused one has been used up, and the control part 63 suspends the coping and other processes at rest conditions.

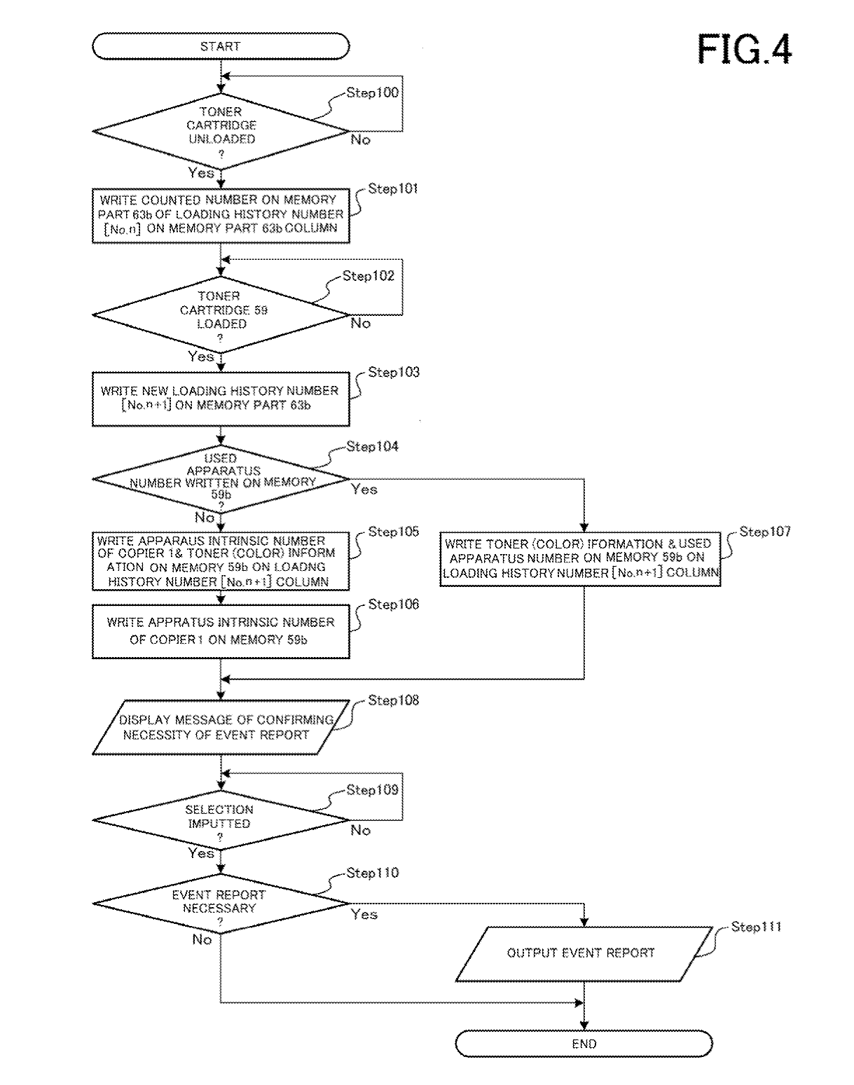

Referring to FIG. 4, the control part 63, using the sensor group 55b and/or the communication apparatus 60 (see FIG. 1), monitors whether or not the toner cartridge 59a is unloaded (Step 100). When the toner cartridge 59 is unloaded, the value of the counted number of sheets that is recorded on the counted number of sheets region of the memory part 63b is written on the current loading history number (No. n) column (Step 101).

Next, the control part 63 monitors whether or not a toner cartridge 59 is loaded (Step 102). If the result is Yes, the control part 63 adds 1 to the value of the loading history number (No. n) and writes the added value of the loading history number (No. n+1) on the space region of the toner replacement history region of the memory part 63b (Step 103).

At this stage, the control part 63 confirms whether or not a used apparatus number has been written on the memory 59b of the IC tag 59 (Step 104).

If the result is No, the control part 63 writes the apparatus intrinsic number of the copy machine 1 and color information included in the toner information that is read from the memory 59b on the above-mentioned loading history number (No. n+1) column (Step 105), and writes the apparatus intrinsic number of the copy machine 1 on the memory 59b (Step 106).

Thereafter, the control 63 causes the liquid crystal display part 62 to display a message to confirm whether or not output ting of a report is necessary regarding the current toner replacement (Step 108).

If the result of the above-mentioned Step 104 is Yes, the control part 63 writes the color information in the toner information and the apparatus intrinsic number on the above-mentioned the loading history number (No. n+1) column and the process proceeds to Step 108.

After the execution of Step 108, the control part 63 waits an input, which is indicative of necessity or unnecessity of outputting an event report (toner replacement report), from the liquid crystal display part 62 or the operation button 61 (Step 109) and if outputting of the event report is found to be unnecessary, the process is terminated.

Otherwise, if outputting of the event report is found to be necessary, the control part 63 takes the information stored in the toner cartridge loading history as a toner cartridge replacement history and forms an image of the toner cartridge replacement history on the recording paper P at the printing part 5 (Step 111) and terminates the process.

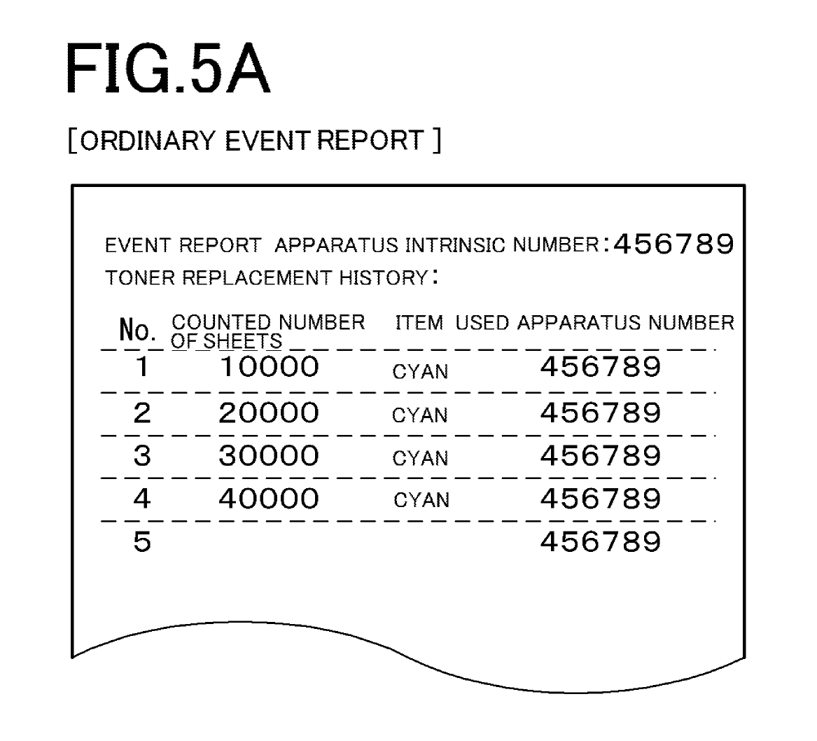

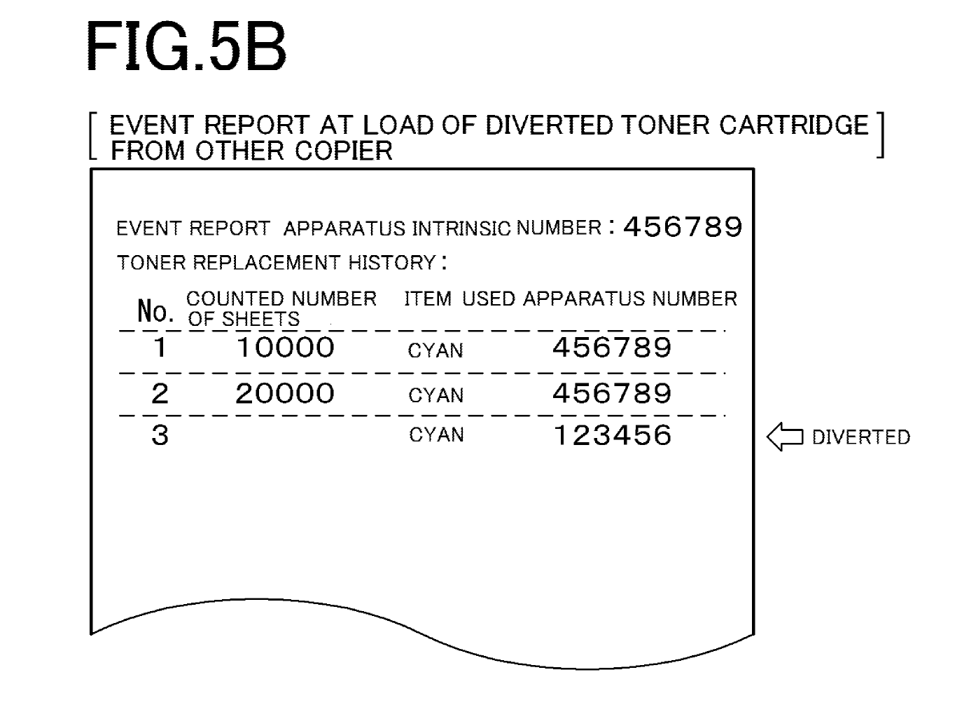

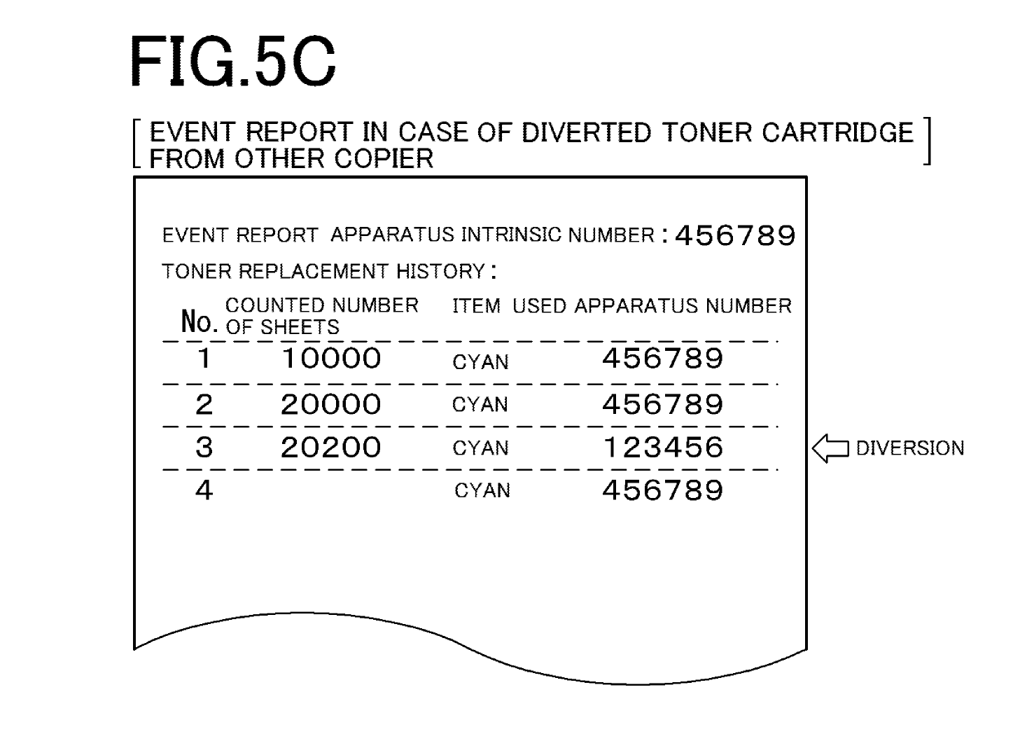

An example of the above-mentioned event report relating to the toner cartridge replacement is shown in FIG. 5 (It is possible to display a similar event report on the liquid crystal display part 62 or the like even though Steps 109 and 110 do not select an unnecessary output of the event report).

FIG. 5A shows the event report indicating that an unused toner cartridge 59 is newly loaded to replace with the preceding loaded toner cartridge 59 whose toner was used up.

On the other hand, the event report shown in FIG. 5B is formed when a toner cartridge 59 is loaded at the third replacement which has been unloaded from another copy machine 1. This report indicates that the used apparatus number at No. 3 is “123456” that is different from the apparatus intrinsic number “456789” of this copy machine 1. Thus, it is possible to recognize that at the third preplacement or the replacement No. 3 an authorized toner cartridge is used (diverted).

In addition, FIG. 5C indicates an event report when a used toner cartridge 59 is loaded at the fourth replacement or No. 4 replacement. Loading the toner cartridge 59 at No. 4 replacement causes an event report to output on which a counted number of sheets are additionally written when the toner in the toner cartridge loaded at No. 3 replacement was used up (that is to say, this report indicates that the toner cartridge 59 loaded at No. 3 replacement was being used in another copy machine 1 or is a reuse of a toner cartridge 59 that was withdrawn from printing use and therefore was used to print only 200 sheets of recording paper P.

### Second Exemplary Embodiment

Hereinbelow, a process flow of the second exemplary embodiment of the present disclosure will be described. It is to be noted that this second exemplary embodiment shall apply the method of accumulating the replacement history of the toner cartridge 59 as shown in FIG. 2B.

In addition, the present exemplary embodiment supposes that the unused toner cartridge 59 is filled with toner enough to form images on 10000 sheets of recording paper P, each portion of the copy machine 1 is free from factors that cause errors in printing and counting the number of sheets, the toner in the toner cartridge 59 to be replaced with the unused one has been used up, and the control part 63 suspends the coping and other processes at rest conditions.

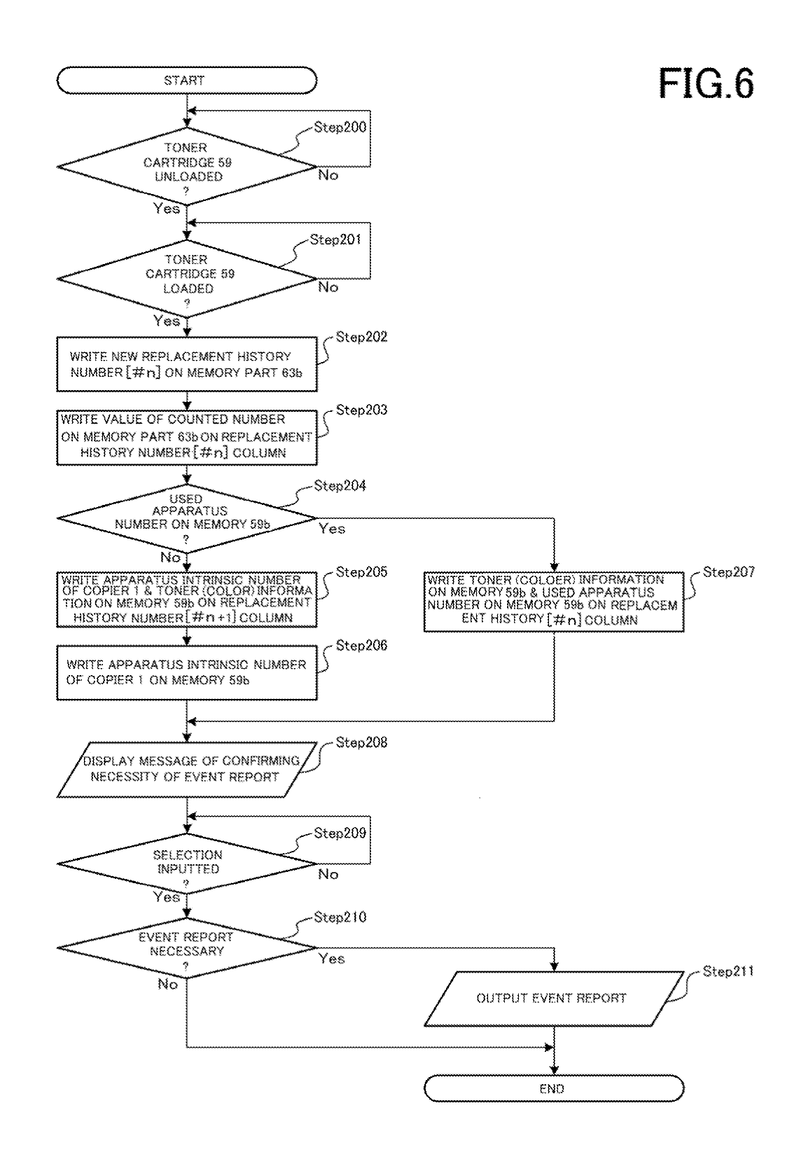

Referring to FIG. 6, the control part 63, using the sensor group 55b and/or the communication apparatus 60 (see FIG. 1), monitors whether or not the toner cartridge 59a is unloaded (Step 200). When the toner cartridge 59 is unloaded and is re-loaded, the control part 63 writes a replacement history number (the number in # column) on the blank region of the toner cartridge replacement history region (the number in # column) and writes the value of the counted number of sheets that is recorded on the counted number of sheets region of the memory part 63b on this replacement history number (# number) column (Step 203).

At this stage, the control part 63 confirms whether or not a used apparatus number has been written on the memory 59b of the IC tag 59 (Step 104).

If the result is No, the control part 63 writes the apparatus intrinsic number of the copy machine 1 and color information included in the toner information that is read from the memory 59b on the above-mentioned the replacement history number (# number) column (Step 205), and writes the apparatus intrinsic number of the copy machine 1 on the memory 59b (Step 206).

Thereafter, the control 63 causes the liquid crystal display part 62 to display a message to confirm whether or not outputting of a report is necessary regarding the current toner replacement (Step 208).

If the result of the above-mentioned Step 204 is Yes, the control part 63 writes the color information in the toner information and the apparatus intrinsic number, and the used apparatus number on the above-mentioned replacement history number (# number) column (Step 207) and the process proceeds to Step 208.

After the execution of Step 208, the control part 63 waits an input, which is indicative of necessity or unnecessity of outputting the event report (toner replacement report), from the liquid crystal display part 62 or the operation button 61 (Step 209) and if outputting of the event report is found to be unnecessary (Step 210), the process is terminated.

Otherwise, if outputting of the event report is found to be necessary, the control part 63 treats the information stored in the toner cartridge loading history as a toner cartridge replacement history and forms an image of the toner cartridge replacement history on the recording paper P at the printing part 5 (Step 211) and terminates the process.

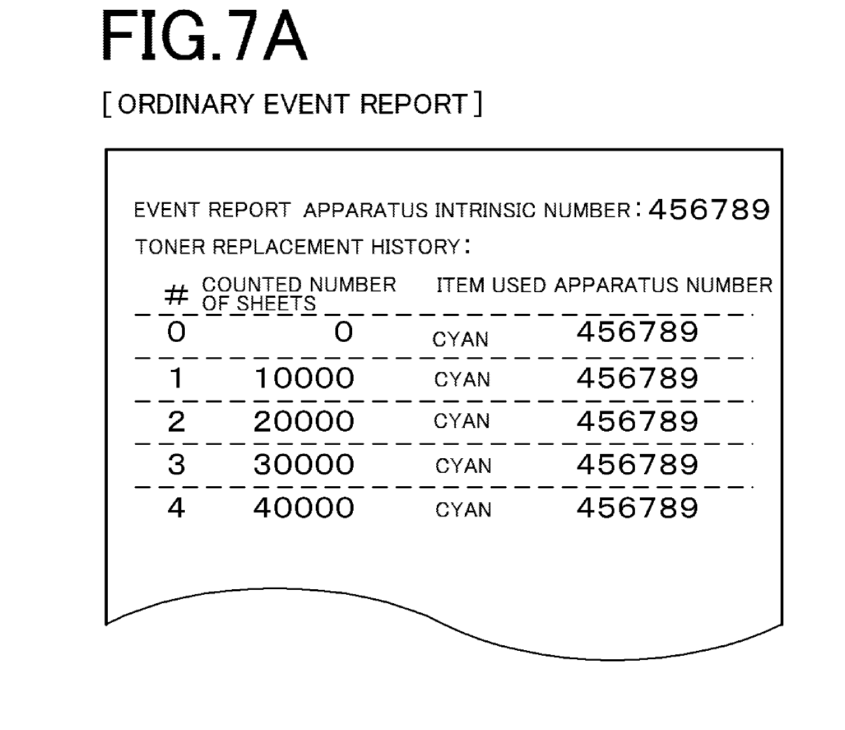

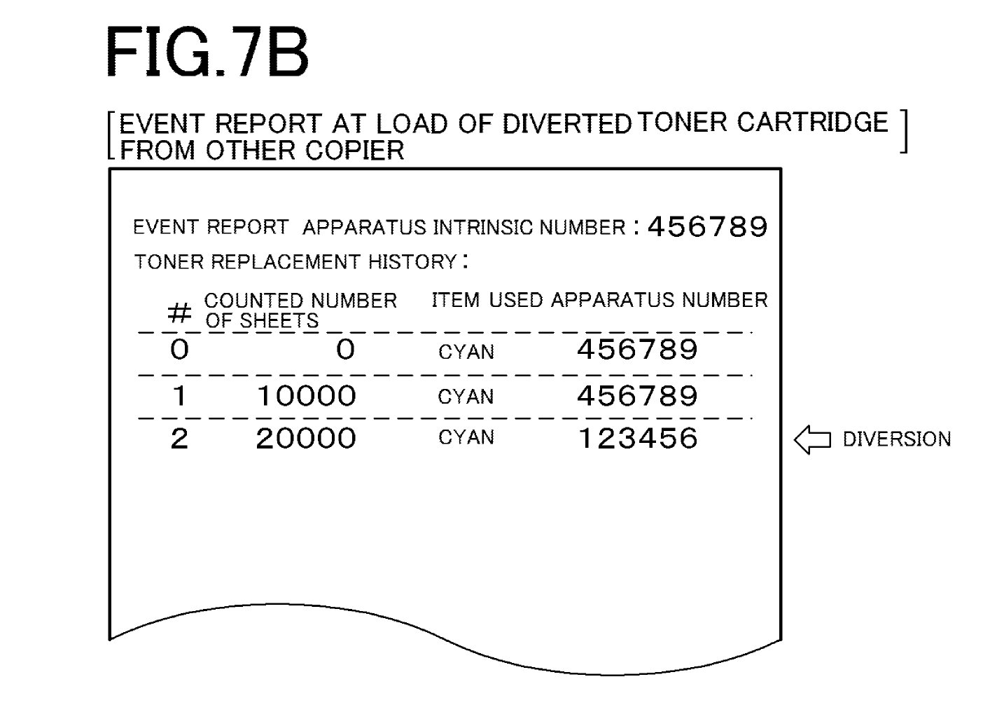

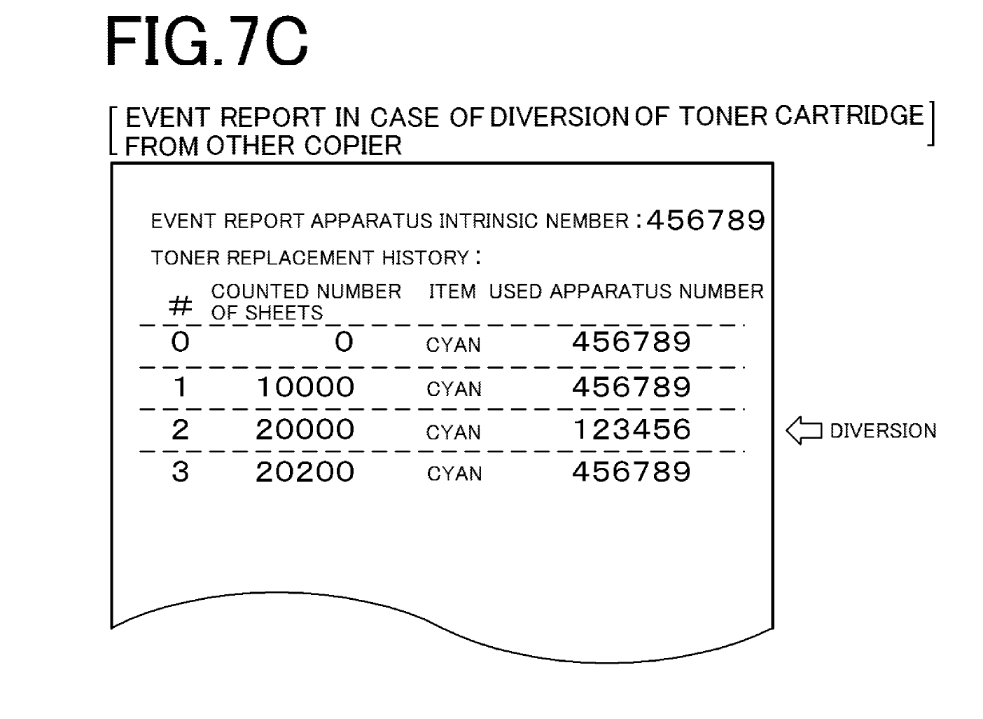

An example of the above-mentioned or preceding event report relating to the toner cartridge replacement in FIG. 7 (It is possible to display a similar event report on the liquid crystal display part 62 or the like even though Steps 209 to S210 do not select an unnecessary output of the event report).

The event report shown in FIG. 7A indicates that an unused toner cartridge 59 is newly loaded to replace with the last used toner cartridge 59 among the toner cartridges 59 whose toners were used up.

On the other hand, the event report shown in FIG. 7B is formed when a toner cartridge 59 is loaded at the second replacement or #2 replacement which has been unloaded from anther copy machine 1. This report indicates that the used apparatus number at #3 replacement is “123456” that is different from the apparatus intrinsic number “456789” of this copy machine 1. Thus, it is possible to recognize that at the second replacement or #2 replacement an authorized toner cartridge is used (diverted).

In addition, FIG. 7C indicates an event report when an unused toner cartridge 59 is loaded at the third replacement or #3 replacement. Outputting the report at the third replacement or #3 replacement provides a count number of sheets that are formed by the toner of the toner cartridge 59 loaded at the third replacement by subtracting the counted number of sheets at the second replacement from the counted number of sheets at the third replacement (that is to say, this report indicates a reuse or diversion of the toner cartridge 59 loaded at #2 replacement was being used in another copy machine 1 or was withdrawn from printing use, and therefor was used to print only 200 sheets of recording paper P).

### Third Exemplary Embodiment

Hereinbelow, a process flow of a third exemplary embodiment of the present disclosure will be described. It is to be noted that this third exemplary embodiment shall apply the method of accumulating the replacement history of the toner cartridge 59 as shown in FIG. 2B.

In addition, the present exemplary embodiment supposes that the unused toner cartridge 59 is filled with toner enough to form images on 10000 sheets of recording paper P, and each portion of the copy machine 1 is free from factors that cause errors in printing and counting the number of sheets.

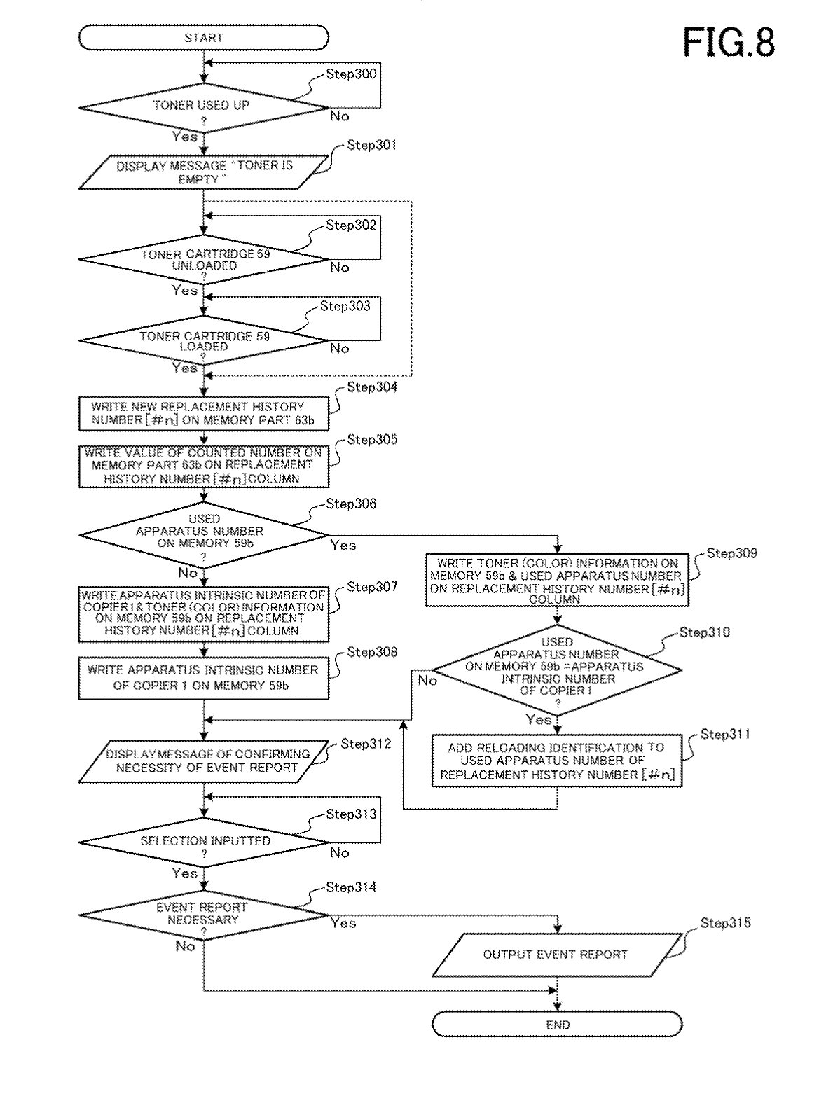

Referring to FIG. 8, the control part 63, using the sensor 55a (see FIG. 1), monitors whether or not the toner in the toner cartridge 59a has been used up (Step 300). At this stage, if it is detected that the toner has been used up, as an example, the control part 63 causes the liquid crystal display part 62 to display at its region 62a a message to the effect that replacement of the toner cartridge 59 is requested (Step 301).

In response to this message, a user of this copy machine 1 replaces the toner cartridge 59 (under such a condition, the control part 63 stops its copying and printing processes).

Next, the control part 63, using the sensor group 55b or the communication apparatus 60, monitors whether or not the toner cartridge 59 is unloaded (Step 302) and whether or not a new toner cartridge 59 is loaded (Step 303). When the toner cartridge 59 is unloaded and is re-loaded, the control part 63 writes a replacement history number (# number) on the blank region of the toner cartridge replacement history region (the number in # column) and writes the value of the counted number of sheets that is recorded on the counted number of sheets region of the memory part 63b on this replacement history number (# number) column (Step 305).

At this stage, the control part 63 confirms whether or not a used apparatus number has been written on the memory 59b of the IC tag 59 (Step 306).

If the result is No, the control part 63 writes the apparatus intrinsic number of the copy machine 1 and color information included in the toner information that is read from the memory 59b on the above-mentioned replacement history number (# number) column (Step 305), and writes the apparatus intrinsic number of the copy machine 1 on the memory 59b (Step 206). Thereafter, the control 63 causes the liquid crystal display part 62 to display a message to confirm whether or not outputting of a report is necessary regarding the current toner replacement (Step 312).

If the result of the above-mentioned Step 306 is Yes, the control part 63 writes the color information in the toner information and the used apparatus number on the above-mentioned replacement history number (# number) column (Step 309).

At this stage in the present third exemplary embodiment, the control part 63 confirms whether or not the used apparatus number is coincident with the apparatus intrinsic number of this copy machine 1 (Step 310) and if the result is No, the process proceeds to Step 312 (This is similar procedure to that of the first exemplary embodiment)

Otherwise, if the result of Step 310 is Yes, the used apparatus number that has been written on the used apparatus number that has been written on the above-mentioned replacement history number (# number) column is added with an identifier indicating the re-loading of the unloaded toner cartridge 59 (Step 311). This identifier is, for example, a suffix to the used apparatus number. Thereafter, the process proceeds to Step 312.

After the execution of Step 312, the control part 63 waits an input, which is indicative of necessity or unnecessity of outputting the event report (toner replacement report), from the liquid crystal display part 62 or the operation button 61 (Step 313) and if outputting of the event report is found to be unnecessary (Step 314), the process is terminated.

Otherwise, if outputting of the event report is found to be necessary, the control part 63 forms the information stored in the toner cartridge replacement history as an image on the recording paper P at the printing part 5 (Step 315) and terminates the process.

It is to be noted that while the third exemplary embodiment, which is shown in FIG. 8, executes procedures that when the toner in the toner cartridge 59 is used up (Step 300), this toner cartridge 59 is unloaded, and after re-loading of the toner cartridge 59 the replacement history number (# number) is written on the blank area of the toner cartridge replacement history region of the memory part 63b (Step 304). Alternatively, it is possible to execute procedures that when the used-up of the toner (that is, toner empty) is detected in Step 300, the result is displayed (Step 301), and immediately the replacement history number (# number) is written on the blank area of the toner cartridge replacement history region of the memory part 63b (Step 304).

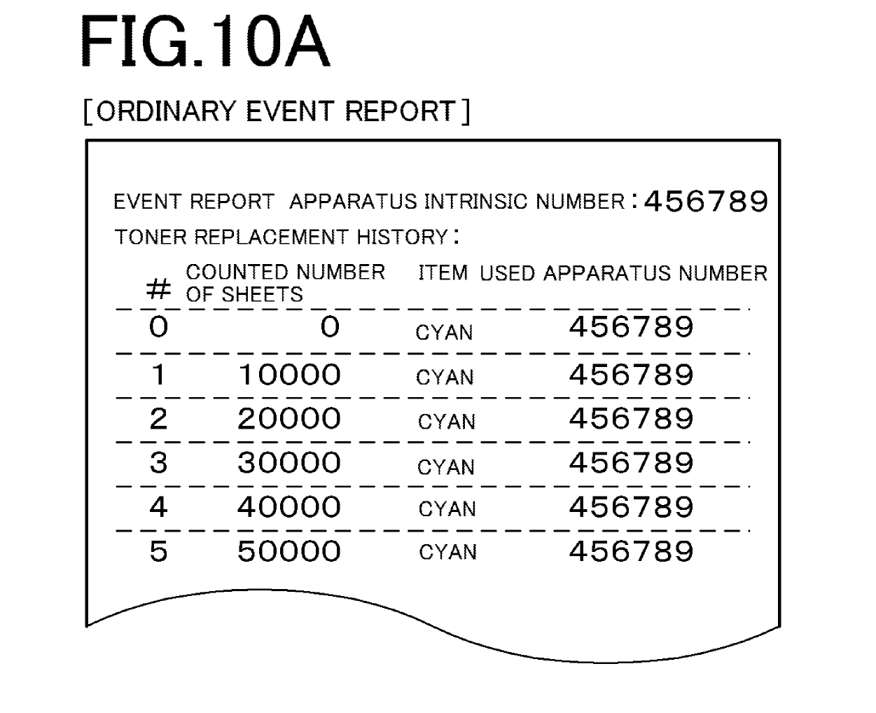

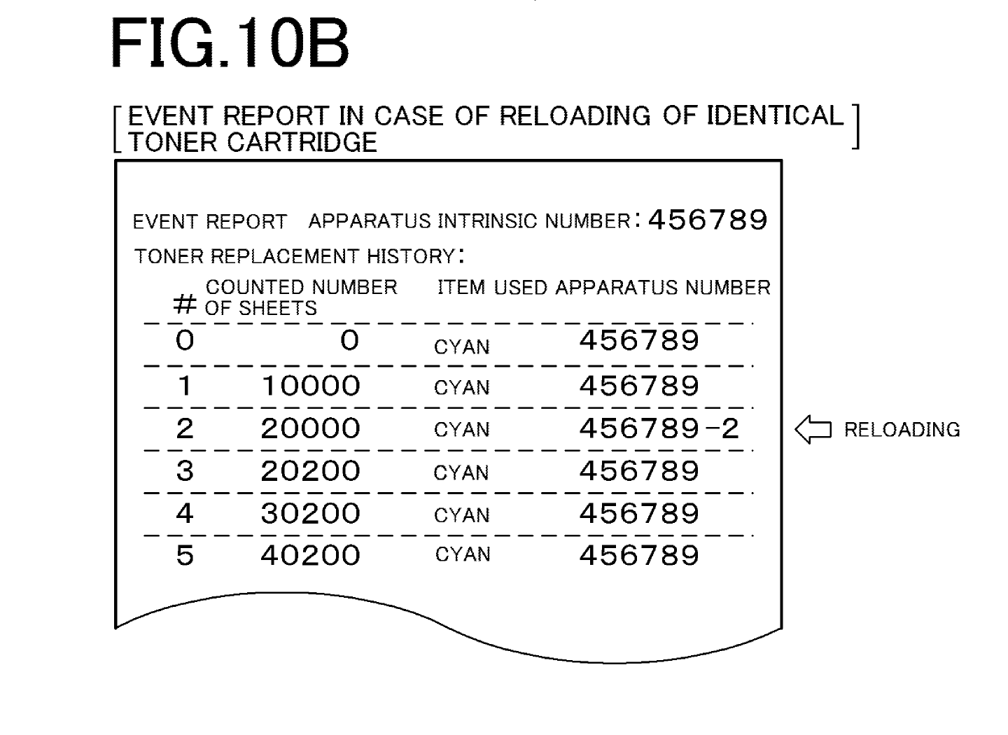

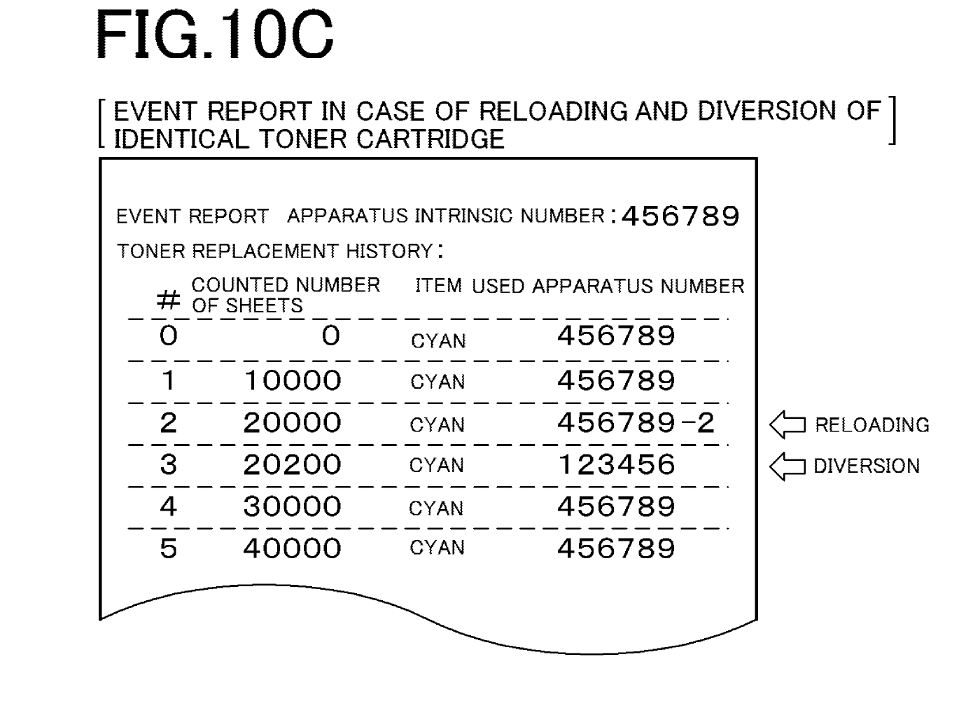

An example of the above-mentioned or preceding event report relating to the toner cartridge replacement is shown in FIG. 10 (It is possible to display a similar event report on the liquid crystal display part 62 or the like even though Steps 313 to 5314 do not select an unnecessary output of the event report).

The event report shown in FIG. 10A indicates that an unused toner cartridge 59 is newly loaded to replace with the last used toner cartridge 59 among the all replaced toner cartridges 59 whose toners were used up.

On the other hand, FIG. 10B indicates an event report in a case of a reloading history of the toner cartridge 59. The example shown in FIG. 10B in which the used apparatus number at #2 replacement is “456789-2” indicates, for example, an unauthorized using manner wherein before #2 replacement the toner cartridge 59 that is temporally unloaded is shaked for stirring toner particles that remain in the toner cartridge 59 (sometimes the toner particles adhere on inner walls of the toner cartridge 59) and the toner cartridge 59 is loaded again to this copy machine 1.

In addition, a counted number of sheets caused by the toner cartridge 59 that is replaced at the second or #2 replacement can be found by calculating a difference between the counted number of sheets at the third or #3 toner replacement and the counted number of sheets at the second or #2 toner replacement (that is, the toner cartridge 59 that is loaded at the second replacement or #2 toner replacement is a reloaded one, which indicates that this toner cartridge 59 is used for printing only 200 sheets of paper.

Furthermore, FIG. 10C shows an event report in which there are provided a reload history of the toner cartridge 59 and a diversion history of the toner cartridge 59 from anther copy machine 1. It is to be noted that a description is omitted regarding the reload of the toner cartridge 59 at the second or #2 toner replacement due to the fact it is identical with that shown in FIG. 10B.

The example of FIG. 10C indicates that at the third or #3 toner replacement the used apparatus number is “123456” and is different from the apparatus intrinsic number “456789” of this copy machine 1. Thus, it is possible to recognize that at the third or #3 toner replacement an unauthorized toner cartridge is used (diverted).

In addition, a counted number of sheets caused by the toner cartridge 59 that is replaced at the third or #3 toner replacement can be found by calculating a difference between the counted number of sheets at the fourth or #4 toner replacement and the counted number of sheets at the third or #3 toner replacement (that is, the toner cartridge 59 that is loaded at the third or #3 toner replacement was used in another copy machine 1 or is a diverted one that was suspended for use, which indicates that this toner cartridge 59 is used for printing only 9800 sheets of paper).

Moreover, in the third exemplary embodiment, as indicated by the example in FIG. 10c, a discrimination of the unauthorized use of the toner cartridge 59 is possible even a mixture of the reload history of the toner cartridge 59 such as one at the second or #2 toner replacement and the diversion history of the toner cartridge 59 such as one at the third or #3 toner replacement which is written another apparatus intrinsic number.

In this way, each of the exemplary embodiments of the disclosure is capable of managing toner cartridges each of which is available for a fixed number of image formed recording sheets. Thereby, even though an unexpected condition occurs in counting the number of image formed sheets due to a replacement in which an unauthorized toner cartridge is loaded, it is possible to avoid, for example, a suspicion against the quality of toner cartridge.

It is apparent that the present disclosure is not necessarily limited to each of the above-mentioned exemplary embodiments and may be modified within the technical scope of the present disclosure.

For example, in a case where an unused toner cartridge 59 is always filled with an amount of toner (available for 10200 sheets of formed-image in each of the above-mentioned exemplary embodiments) that is slightly larger than a fixed amount of toner (available for 10000 sheets of formed-image in each of the above-mentioned exemplary embodiments), when the control part 63 recognizes, based on the value of counted number of sheets on the memory part 63b, that the number of sheets of formed-image reaches the fixed amount since the toner cartridge 59 has been loaded, the control part 63 regards that the toner cartridge 59 becomes empty, and the control part 63 allows for issuing a request for replacing the toner cartridge 59 (However, in such a case, when the sensor 55a detects that the toner is found to be unremoved from the toner cartridge 59, the control part 63 determines that the toner cartridge 59 is in trouble and therefore makes a replacing the toner cartridge 59).

Additionally, the control part 63 is capable of discriminating that the toner cartridge 59 has a history of being diverted or reloaded from the used apparatus number in the toner cartridge loading history or the toner cartridge replacement history that are recorded on the memory part 63b. Thus, in a case where such a history being diverted or reloaded, it is possible to add the wording “diverted” or “reloaded” for indication on the event reports that are shown in FIG. 5, FIG. 7 or FIG. 10. Alternatively, in a similar case, even though an unnecessity of outputting of an event report is selected, it may be forced the event report to form as an image on a recording paper P.

Moreover, in a case where the used apparatus number has been written on the memory 59a of the IC tag 59a, the control part 63 makes a comparison between the used apparatus number and the apparatus intrinsic number of the copy machine 1 and if the result is No, it is possible to employ a configuration that rejects a load of the toner cartridge 59. In other words, in a case where the used apparatus number (second apparatus intrinsic number) has been written on the use history area of the memory 59b and concurrently this used apparatus number is different from the apparatus intrinsic number (first apparatus intrinsic number), the control part 63 refuses to use such a consumable (toner cartridge 59). In such a case, for example, after loading the toner cartridge 59 at issue, the control part 63 causes the liquid crystal display 62 to indicate a warning message saying, for example, “DIVERTED OR RELOADED TONER CONTAINER” for the prevention of printing. In occurrence with issuing this warning message, it is possible to transmit the aforementioned message to a manager of the copy machine 1 via a network or a telephone line that are not shown.

It is to be noted that the same reference codes denotes the same elements throughout the drawings.

In summary, for example, in a typical case, managing use start date and final use date and the like for each the toner cartridge is performed such that the serial numbers (intrinsic numbers) written in the IC tag are recognized, and the used histories of the toner cartridges are recorded on the copier.

Further, another typical case is disclosed wherein an identification is made as to whether or not replacement warning information is written in the IC tag, thereby preventing the toner cartridge from being loaded into a faulty position in the copier in which plural toner cartridges are loaded for use therein.

Furthermore, another typical case is disclosed wherein, based on the information written in the IC tag of a toner cartridge, an identification is made as to whether or not this toner cartridge is a certified product, and the result is written in the copier, thereby recording the use history of imitation products or the like.

Moreover, another typical case is disclosed wherein causing the information pieces such as a consumable and the like written on the IC tag to being recorded in the copier is made for confirming how the consumable and the like are used and whether or not these are replaced timely.

Incidentally, sometimes, in a copy machine that uses a toner cartridge that is filled with a toner, when the toner cartridge is empty, a toner in use is unloaded from another copy machine of the same model and replaced with the empty toner cartridge, or a toner cartridge of the same type having a use history in another copy machine is replaced (diverted) with the empty toner cartridge. Otherwise, even though the copier recognizes that the toner cartridge is empty, reloading the toner cartridge after stirring a small amount of residual toner powder in the toner cartridge by shaking the toner cartridge may print copy (print) several hundreds of papers.

However, in a case of an unauthorized use such as loading a toner cartridge that was used in another copier or reloading a toner cartridge after shaking the same, this toner cartridge is obliged to be replaced before reaching the specified number of sheets of this toner cartridge.

In a copier in which the counted number of sheets (the number of copies or the number of printing sheets) is recorded on a toner cartridge replacement, an unauthorized use of the toner cartridge will record a history of extremely small number of printing sheets.

However, it is impossible for the typical cases as described in paragraphs [0065] and [0066] to confirm whether or not the toner cartridge is in an unauthorized use.

In addition, recording the history of extremely small number of printing sheets in the toner cartridge replacement history may cause many users to have a doubt of the quality of the toner cartridge (Quality Control).

In view of the above-mentioned circumstances, the present disclosure is made and its object is to provide an image forming apparatus and a consumable cartridge managing method both of which are capable of avoiding a suspiciousness against consumable quality even when the consumable cartridge such as a toner cartridge becomes empty too quickly due to its unauthorized use.

In brief, according to the present disclosure, the present disclosure is capable of exerting effects of properly managing usages of a toner cartridge whose capacity of forming the number of image is fixed, thereby avoiding suspiciousness against toner cartridge quality even when an unusual error is occurred in counted number of image formation caused by an unauthorized toner cartridge replacement.

What is claimed is:

1. An image forming apparatus that is configured to replaceably load a consumable cartridge with an IC tag having a memory with a use history region, the image forming apparatus, comprising:
a read/write part that is configured to read/write an information piece from/to the IC tag; and
a control part that has a memory part on which a first apparatus intrinsic number is written,
the control part being configured to determine, when the consumable cartridge is loaded, whether or not a second apparatus intrinsic number as a use history is written on the use history region of the memory,
the control part being configured to, when the second intrinsic apparatus number is not written on the use history region, write the first apparatus intrinsic number on the use history region and records additionally the first apparatus intrinsic number as the second intrinsic number on a replacement history region or a loading history region of the memory part, the control part being configured to record additionally the second apparatus intrinsic number on the replacement history region or the loading history region of the memory part when the second apparatus intrinsic number is written on the use history region.

2. An image forming apparatus that is configured to replaceably load a consumable cartridge with an IC tag having a memory with a use history region, the image forming apparatus, comprising:
a read/write part that is configured to read/write an information piece from/to the IC tag; and
a control part that has a memory part on which a first apparatus intrinsic number is written,
the control part being configured to determine, when the consumable cartridge is loaded, whether or not a second apparatus intrinsic number is written as a use history is written on the use history region of the memory,
the control part being configured to, when the second apparatus intrinsic number is not written on the use history region, write the first apparatus intrinsic number on the use history region and records additionally the first apparatus intrinsic number as the second apparatus intrinsic number on a replacement history region or a loading history region of the memory part,
the control part being configured to write additionally the second apparatus intrinsic number on the replacement history region or the loading history region of the memory part when the second intrinsic apparatus number is written on the use history region and concurrently when the second apparatus intrinsic number is different from the first apparatus intrinsic number, the control part being configured to write additionally the second apparatus intrinsic number that is added with a specific identification information piece on the replacement history region or the loading history region of the memory part if the second apparatus intrinsic number is written on the use history region and concurrently when the second apparatus intrinsic number is identical with the first apparatus intrinsic number.

3. The image forming apparatus according to claim 1, further comprising a display part on which various information pieces are to be displayed by the control part, wherein the control part performs a counting operation whenever a consumption amount of a consumable accommodated in the consumable cartridge reaches a specified value and stores the counted number in a count region of the memory part for accumulation, and the control part, when the consumable cartridge is loaded, stores additionally a paired combination of the counted number and the second apparatus intrinsic number on the replacement history region of the memory part and causes the display part to display information in the replacement history region.

4. The image forming apparatus according to claim 1, further comprising a printing part that is to be caused to form an image on a recording paper by the control part, wherein the control part performs a counting operation whenever a consumption amount of a consumable accommodated in the consumable cartridge reaches a specified value and stores the counted number in a count region of the memory part for accumulation, and the control part, when the consumable cartridge is loaded, stores additionally a paired combination of the counted number and the second apparatus intrinsic number on the replacement history region or the loading history part of the memory part and causes the display part to form an image of the information in the replacement history region or the loading history information.

5. The image forming apparatus according to claim 1, wherein the IC tag includes a control circuit for reading and writing information from and to the memory, respectively and an RF ID tag having a first antenna that the control circuit uses for transmitting and receiving information, the read/write part includes a second antenna for reading and writing information from and to the first antenna, respectively, via an electromagnetic wave and a transmitting/receiving circuit for inputting and outputting the information that is transmitted and received selectively by the second antenna to and from the control part, and the control part reads and writes, via the read/write part, information from and to, respectively, the IC tag in a contactless manner.

6. The image forming apparatus according to claim 2, further comprising a display part on which various information pieces are to be displayed by the control part, wherein the control part performs a counting operation whenever a consumption amount of a consumable accommodated in the consumable cartridge reaches a specified value and stores the counted number in a count region of the memory part for accumulation, and the control part, when the consumable cartridge is loaded, stores additionally a paired combination of the counted number and the second apparatus intrinsic number on the replacement history region of the memory part and causes the display part to display information in the replacement history region.

7. The image forming apparatus according to claim 2, further comprising a printing part that is to be caused to form an image on a recording paper by the control part, wherein the control part performs a counting operation whenever a consumption amount of a consumable accommodated in the consumable cartridge reaches a specified value and stores the counted number in a count region of the memory part for accumulation, and the control part, when the consumable cartridge is loaded, stores additionally a paired combination of the counted number and the second apparatus intrinsic number on the replacement history region or the loading history part of the memory part and causes the printing part to form an image of information in the replacement history region or the loading history information.

8. The image forming apparatus according to claim 2, wherein the IC tag includes a control circuit for reading and writing information from and to the memory, respectively and an RF ID tag having a first antenna that the control circuit uses for transmitting and receiving the information, the read/write part includes a second antenna for reading and writing information from and to the first antenna, respectively, via an electromagnetic wave and a transmitting/receiving circuit for inputting and outputting the information that is transmitted and received selectively by the second antenna to and from the control part, and the control part reads and writes, via the read/write part, information from and to, respectively, the IC tag in a contactless manner.

9. A consumable cartridge managing method that is associated with an image forming apparatus that is configured to be loaded with a consumable cartridge in a replaceable manner which is attached with an IC tag having a memory with a use history region, the image forming apparatus including a read/write part that is configured to read/write an information piece from/to the IC tag, and a control part that has a memory part on which a first apparatus intrinsic number is written, the consumable cartridge managing method comprising the steps of;
causing the control part to determine, when the consumable cartridge is loaded, whether or not a second apparatus intrinsic number as a use history is written on the use history region of the memory;
causing the control part to write the first apparatus intrinsic number on the use history region when the second apparatus intrinsic number is not written on the use history region and to record additionally the first apparatus intrinsic number as the second apparatus intrinsic number on a replacement history region or a loading history region of the memory part; and
causing the control part to record additionally the second apparatus intrinsic number on the replacement history region or the loading history region of the memory part when the second apparatus intrinsic number is written on the use history region.

10. A consumable cartridge managing method associated with an image forming apparatus that is configured to replaceably load a consumable cartridge with an IC tag having a memory with a use history region, the image forming apparatus including a read/write part that is configured to read/write an information piece from/to the IC tag and a control part that has a memory part on which a first apparatus intrinsic number is written, the consumable cartridge managing method comprising the steps of;
causing the control part to determine, when the consumable cartridge is loaded, whether or not a second apparatus intrinsic number is written as a use history on the use history region of the memory;
causing the control part to write the first apparatus intrinsic number on the use history region when the second intrinsic number is not written on the use history region and to record additionally the first apparatus intrinsic number as the second apparatus intrinsic number on a replacement history region or a loading history region of the memory part;
causing the control part to write additionally the second apparatus intrinsic number on the replacement history region or the loading history region of the memory part when the second apparatus intrinsic number is written on the use history region and concurrently when the second apparatus intrinsic number is different from the first intrinsic number; and
causing the control part to write additionally the second apparatus intrinsic number that is added with a specific identification information piece on the replacement history region or the loading history region of the memory part when the second apparatus intrinsic number has been written on the use history region and concurrently if the second apparatus intrinsic number is identical with the first apparatus intrinsic number.

11. The consumable cartridge managing method according to claim 9, wherein the image forming apparatus further comprises a display part on which various information pieces are to be displayed by the control part, and wherein the control part performs a counting operation whenever a consumption amount of a consumable accommodated in the consumable cartridge reaches a specified value and stores the counted number in a count region of the memory part for accumulation, and the control part, when the consumable cartridge is loaded, stores additionally a paired combination of the counted number and the second apparatus intrinsic number in the replacement history region of the memory part and causes the display part to display information in the replacement history region.

12. The consumable cartridge managing method according to claim 9, wherein the image forming apparatus further comprises a display part on which various information pieces are to be displayed by the control part, wherein the control part performs a counting operation whenever a consumption amount of a consumable accommodated in the consumable cartridge reaches a specified value and stores the counted number in a count region of the memory part for accumulation, and the control part, when the consumable cartridge is loaded, stores additionally a paired combination of the counted number and the second apparatus intrinsic number on the replacement history region of the memory part and causes the display part to display information in the replacement history region.

13. The consumable cartridge managing method according to claim 10, wherein the image forming apparatus further comprises a display part on which various information pieces are to be displayed by the control part, and wherein the control part performs a counting operation whenever a consumption amount of a consumable accommodated in the consumable cartridge reaches a specified value and stores the counted number in a count region of the memory part for accumulation, and the control part, when the consumable cartridge is loaded, stores additionally a paired combination of the counted number and the second apparatus intrinsic number on the replacement history region of the memory part and causes the display part to display information in the replacement history region.

14. The consumable cartridge managing method according to claim 10, wherein the image forming apparatus further comprises a display part on which various information pieces are to be displayed by the control part, wherein the control part performs a counting operation whenever a consumption amount of a consumable accommodated in the consumable cartridge reaches a specified value and stores the counted number in a count region of the memory part for accumulation, and the control part, when the consumable cartridge is loaded, stores additionally a paired combination of the counted number and the second apparatus intrinsic number on the replacement history region of the memory part and causes the display part to display information in the replacement history region.
